(19) United States
(12) Patent Application Publication
(10) Pub. No.: US 2006/0017367 A1
(43) Pub. Date: Jan. 26, 2006

(54) Light source

(75) Inventor: Jorg Arnold, Bern (CH)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: IP2H AG

(21) Appl. No.: 11/206,374

(22) Filed: Aug. 18, 2005

Related U.S. Application Data
(63) Continuation of application No. PCT/DE03/05389, filed on Feb. 20, 2003.

(51) Int. Cl. H01J 1/62; H01J 63/04; H01J 17/16

(52) U.S. Cl. 313/490; 313/635; 313/489

(57) ABSTRACT

A light source having a heatable filament 1 or an electrode, with the filament 1 or electrode being arranged in a bulb or tube 2. The bulb or tube 2 comprises an inner surface 3 and an outer surface 4, and to extend the service life of the light source, an agent 7 is arranged in the bulb or tube for removing contaminants and/or deposits 8 from the inner surface 3.

### CROSS REFERENCE TO RELATED APPLICATION

The present application is a continuation of international application PCT/DE2003/000538, filed 20 Feb., 2003, and which designates the U.S. The disclosure of the referenced application is incorporated herein by reference.

### BACKGROUND OF THE INVENTION

The present invention relates to a light source with a heatable filament or an electrode, with the filament or the electrode being arranged in a bulb or tube, and with the bulb or the tube comprising an inner surface and an outer surface.

Light sources of the type under discussion have been known from practice for a long time, and they exist in a great variety of designs and sizes. They are known in particular as electric incandescent lamps, electric halogen lamps, and electric discharge lamps in low-pressure or high-pressure designs, as well as electronic light-emitting diodes. The light sources are based on thermionic emission, collision excitation of gases, or a luminescence effect, for example, in luminescent tubes.

For example, in the case of a light source in the form of an incandescent lamp, a bulb accommodates a heatable filament, which is heated to a high temperature for emitting light. At this high temperature, chemical reaction processes frequently occur between the gaseous atmosphere in the bulb and the filament. Furthermore, depending on the heating temperature, an evaporation of the filament material is possible. These processses may occur suddenly, momentarily, and forcefully. In the end, they may cause material to deposit on the inner surface of the bulb, which impedes or even totally obstructs transmission of the light emitted by the filament through the bulb. For example, the use of tantalum carbide filaments may cause carbon deposits to develop on the inner surface of the bulb.

The foregoing deposits and contaminants on the inner surface of the bulb limit the entire service life of a light source, since correspondingly large quantities of deposits are able to reduce transmission of the generated light through the bulb so considerably that the light quantity generated by means of the light source is no longer adequate for the desired application. Last but not least, it will then become necessary to replace the light source with a new light source, which ensures the required light output. Such a replacement of the light source involves costs and causes an environmental impact.

It is therefore an object of the present invention to provide a light source of the initially described type, which permits extending the service life of the light source with constructionally simple means.

### SUMMARY OF THE INVENTION

In accordance with the invention, the foregoing object is accomplished by the provision of a light source of the initially described type and which is improved and further developed by means of an agent arranged in the bulb or tube for removing contaminants and/or deposits on the inner surface.

In accordance with the invention, it has been found that it is not absolutely necessary to replace or dispose of a light source, when the transmission of light through the bulb is reduced by contaminants and/or deposits on the inner surface of the bulb. To achieve the foregoing object in a surprisingly simple manner, an agent for removing contaminants and/or deposits from the inner surface is arranged in the bulb or tube. Such an agent makes it possible to remove contaminants and/or deposits from the inner surface of the bulb or tube, which results in making the light source again operable with improved transmission. With that, a replacement of the light source becomes unnecessary.

Consequently, the light source of the invention provides a light source, whose service life is extended with constructionally simple means.

To ensure a particularly safe removal of contaminants and/or deposits from the inner surface, the agent could be adapted for movement over the inner surface. This ensures a reliable interaction of the agent with the contaminants and/or deposits on the inner surface of the bulb or tube.

With respect to a safe engagement between the agent and the contaminants and/or deposits, the agent could include a solid. As a specific example, the agent for safely removing the contaminants and/or deposits could be an abrasive.

In a specific realization, the agent could include a powder or granules, thereby making available a particularly simple means.

As an alternative or in addition thereto, the agent could include grit, or chips, or wool. In this case, adjustments need to be made to the particular case of application and to the particular circumstances necessitated by the bulb or the tube.

Furthermore, with respect to a safe removal of contaminants and/or deposits, the agent could include a solvent. In this case, a chemical dissolution of the contaminants and/or deposits could occur as an alternative or in addition to a mechanical cleaning effect.

In a particularly practical manner, the agent could be paramagnetic. In this case, the agent could be guided by means of a magnet from the outside of the bulb or tube along the inner surface of the bulb or tube. Specifically, a magnet could be associated to this end to the outside of the bulb or tube.

As regards the movement of the magnet outside the bulb or tube, quasi any movement of the magnet could be performed by hand. In a particularly comfortable configuration of the light source, a guideway for the magnet, for example in the form of rails could be associated to the bulb or tube. In this case, the magnet could be moved by hand along the guideway, which indirectly predetermines the area of the inner surface that can be cleaned. The movement of the magnet along the guideway could also occur by means of an additional movement device, which mechanically moves the magnet along the guideway. Specifically, the magnet could be moved by means of a rope or a chain. In this case, a timed and quasi automatic removal of contaminants and/or deposits is made possible.

In a further realization, the agent could be devised for chemically and/or physically binding the contaminants and/or deposits at least in part. As regards a physical binding of the contaminants and/or deposits, it would be possible to provide for a magnetic interaction of the agent and the contaminants and/or deposits. By binding the contaminants and/or deposits, same are prevented from impeding the operation of the light source after their removal from the inner surface of the bulb or tube.

To avoid disturbing reactions with an existing process gas, the agent could comprise a coating. Advantageously, such a coating could be chemically largely inert, so that reactions with a process gas are very reliably avoided.

With respect to a durable stability of the coating, the latter could be temperature-resistant, in particular resistant to high temperatures. With that, an adverse effect of the coating and function of the agent is largely avoided also at a high operating temperature of the filament and a correspondingly high heat radiation on the agent.

To prevent disturbing gases from leaving the agent, the coating could have a low vapor pressure, thereby ensuring a durable coating.

Specifically, the coating could be ceramic, in particular oxide ceramic, which permits realizing a particularly reliable and simple coating.

As an alternative or in addition, the coating could include a metal, in particular tantalum, which has a low vapor pressure.

With respect to a reliable storage of the agent, and/or the contaminants, and/or the deposits in the bulb or tube, the agent, the contaminants, and/or deposits could be adapted for arrangement in a storage area of the bulb or tube after their removal. With that, an interference with the operation of the light source by the agent, and/or the contaminants, and/or the deposits is avoided. Such a storage area could be a region that is relatively unheated during the operation of the light source. With that, an evaporation and/or disturbing reactions between the agent, and/or the contaminants, and/or deposits and an existing process gas and/or the filament or an electrode are largely avoided.

With respect to a particularly reliable storage of the agent, and/or the contaminants, and/or the deposits, a securing device for the agent, and/or the contaminants, and/or the deposits could be associated to the storage area. In a particularly simple manner, such a securing device could include a magnet and/or adhesive. With that, a particularly safe storage of the agent, and/or the contaminants, and/or the deposits is realized.

With the use of tantalum carbide filaments, carbon could be a deposit, which causes the inner surface of the bulb or tube to be coated with soot. Iron could be used as a paramagnetic agent or paramagnetic solid.

Upon appearance of a deposit, it would be possible to remove in the bulb or tube a possible soot coating and/or contamination and/or deposit by means of a loose abrasive solid, for example, by moving the powder, granules, grit, chips, or wool over the inner surface of the bulb or tube, which is sooted, contaminated, and covered with deposits, for example, by means of a magnet that is guided on the outside of the bulb or tube. In so doing, the solid abrades the soot, and/or the contaminants, and/or deposits, and would be in a position to also bind them in part. After this cleaning or regeneration process, the used abrasive solid could be secured likewise by a magnet or an adhesive in the bulb or tube, for example, in a unheated area thereof, so that the solid does not impede the operation of the lamp by contacting the filament, or electrode, or filament stems, or electric contacts.

Should an elementary iron that is used as agent, or a paramagnetic material that is considered for use, cause disturbing reactions with existing process gases, it would be possible to coat the agent or solid particles in use, for example, with a chemically largely inert solid, such as, for example ceramic materials or oxide ceramics that are resistant to high temperatures, or metals, such as, for example, tantalum with a low vapor pressure.

There exist various possibilities of improving and further developing the teaching of the present invention in an advantageous manner. To this end, one may refer on the one hand to the claims and on the other hand to the following description of two preferred embodiments of the invention with reference to the drawings. In conjunction with the description of the preferred embodiments of the invention with reference to the drawings, also generally preferred improvements and further developments or the teaching are described in greater detail.

### BRIEF DESCRIPTION OF THE DRAWINGS

FIG. 1 is a schematic side view of a first embodiment of a light source according to the invention, and

FIG. 2 is a schematic side view of a second embodiment of a light source according to the invention.

### DETAILED DESCRIPTION OF THE PREFERRED EMBODIMENTS

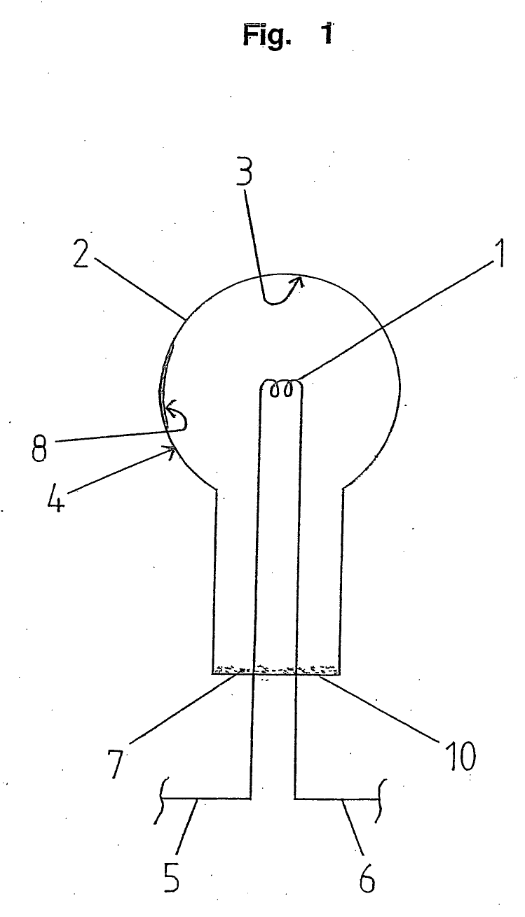

FIG. 1 illustrates a light source which comprises a heatable filament 1, which is arranged in a bulb 2. The bulb 2 comprises an inner surface 3 and an outer surface 4. The filament 1 can be heated via electric contacts 5 and 6.

With respect to extending the service life of the light source, the light source is equipped such that the bulb 2 accommodates an agent 7 for removing contaminants and/or deposits 8 from the inner surface 3. The agent 7 is adapted for movement over the inner surface 3. To this end, the bulb 2 may be moved by hand, so that the agent 7 comes into contact with these deposits 8 and abrades them from the inner surface 3. To this end, the agent 7 is provided in the form of an abrasive. Specifically, the agent 7 includes a powder or granules.

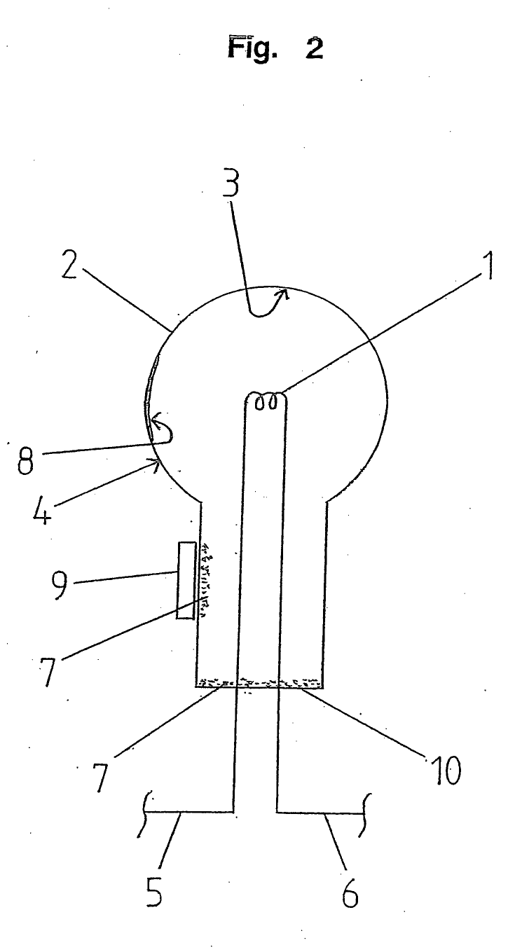

A second possibility of removing the deposits 8 and/or the contaminants consists in that the agent 7 is paramagnetic and adapted for movement along the inner surface 3 by means of a magnet 9 shown in FIG. 2. In this case, it will not be necessary to move the bulb 2 for removing the contaminants and/or deposits 8.

Both the first embodiment shown in FIG. 1 and the second embodiment of a light source shown in FIG. 2 comprise a storage area 10 of the bulb 2, which is adapted for receiving the agent 7, and/or the contaminants, and/or deposits 8. With that, it is avoided that the operation of the light source is interfered with by the agent 7, and/or the contaminants, and/or deposits 8 arranged in the bulb 2. The storage area 10 is a relatively unheated region during the operation of the light source.

Furthermore, one could associate to the storage area 10 a securing device for the agent 7, and/or the contaminants, and/or the deposits 8. Such a securing device could include a magnet or an adhesive, which can both be used for retaining the agent 7, and/or the contaminants, and/or deposits 8 in the storage area 10.

As regards further advantageous improvements and further developments of the teaching according to the invention, the general part of the specification on the one hand and the attached claims on the other hand are herewith incorporated by reference for purposes of avoiding repetitions.

Finally, it should be expressly remarked that the foregoing, merely randomly selected embodiments serve only to explain the teaching of the invention, without however limiting it to these embodiments.

1. A light source comprising a heatable filament or electrode arranged in a bulb or tube, with said bulb or tube having an inner surface and an outer surface, and an agent arranged in the bulb or tube for removing contaminants and/or deposits from the inner surface.

2. The light source of claim 1, wherein the agent is configured to permit movement over the inner surface.

3. The light source of claim 1, wherein the agent includes a solid.

4. The light source of claim 1, wherein the agent is an abrasive.

5. The light source of claim 1, wherein the agent includes a powder or granules.

6. The light source of claim 1, wherein the agent includes grit, or chips, or wool.

7. The light source of claim 1, wherein the agent includes a solvent.

8. The light source of claim 1, wherein the agent is paramagnetic.

9. The light source of claim 1, wherein a magnet is positioned adjacent the outer surface of the bulb or tube.

10. The light source of claim 9, wherein a guideway for the magnet is associated with the bulb or tube.

11. The light source of claim 1, wherein the agent is constituted for chemically and/or physically binding the contaminants and/or deposits at least in part.

12. The light source of claim 1, wherein the agent includes a coating.

13. The light source of claim 12, wherein the coating is chemically essentially inert.

14. The light source of claim 12, wherein the coating is temperature resistant.

15. The light source of claim 12, wherein the coating has a low vapor pressure.

16. The light source of claim 12, wherein the coating includes a ceramic material.

17. The light source of claim 12, wherein the coating includes a metal.

18. The light source of claim 1, wherein the agent, and/or the contaminants, and/or deposits is or are adapted for arrangement in a storage area of the bulb or tube.

19. The light source of claim 18, wherein the storage area is in a relatively unheated region of the bulb or tube during the operation of the light source.

20. The light source of claim 18 wherein a securing device for the agent, and/or the contaminants, and/or deposits is associated with the storage area.

21. The light source of claim 20, wherein the securing device includes a magnet or an adhesive.
